(19) United States
(12) Patent Application Publication
(10) Pub. No.: US 2017/0118683 A1
(43) Pub. Date: Apr. 27, 2017

(54) WIRELESS COMMUNICATION SYSTEM AND HANDOVER METHOD THEREOF

(71) Applicant: Intellectual Discovery Co., Ltd., Seoul (KR)

(72) Inventors: Ju Hyung SON, Uiwang-si, Gyeonggi-do (KR); Jin Sam KWAK, Uiwang-si, Gyeonggi-do (KR); Hyun Oh OH, Gwacheon-si, Gyeonggi-do (KR)

(73) Assignee: INTELLECTUAL DISCOVERY CO., LTD., Seoul (KR)

(21) Appl. No.: 15/129,515

(22) PCT Filed: Jan. 19, 2015
(86) PCT No.: PCT/KR2015/000508

§ 371 Date: Sep. 27, 2016

(30) Foreign Application Priority Data
Mar. 31, 2014 (KR) 10-2014-0038273
Mar. 31, 2014 (KR) 10-2014-0038278

(51) Int. Cl. H04W 36/02; H04L 12/58

(52) U.S. Cl. CPC H04W 36/023; H04L 51/10; H04W 16/32

(57) ABSTRACT

The present invention provides a wireless communication device comprising: a communication module for receiving multimedia data from a base station of a wireless communication system; and a multimedia module for playing the received multimedia data, wherein the communication module receives a backhaul delay time of a base station on which handover is to be performed and performs handover from a current base station to the base station on which handover is to be performed, and when the communication module performs handover, the multimedia module controls a playback time of the multimedia data on the basis of the backhaul delay time, and the backhaul delay time is precalculated by the wireless communication system.

### TECHNICAL FIELD

The present disclosure relates to a wireless communication system and a handover method thereof.

### BACKGROUND

With the continuous advancement of wireless communication systems (telecommunication systems), the standard organizations such as 3GPP, IEEE, etc. have developed standards.

According to the development trend of wireless communication systems, 3GPP has standardized cellular-WLAN interworking and small cell access in order to solve the explosive growth of data traffic of cellular systems while developing LTE-A standards.

However, a small cell has a disadvantage that it has a longer delay in case of handover than a macro cell. Such a disadvantage may cause a problem particularly when a wireless communication device receives a multimedia packet. Due to a delay in handover, a user may experience some disturbance such as pause of multimedia streaming or repeated playing of the same section.

Therefore, there is a need of a method that enables multimedia data to be normally played in a wireless communication device of a user even if there is a delay in handover.

In this regard, U.S. Pat. No. 8,279,830 (“Method of performing handover for a dual transfer mode in a wireless mobile communication system”) disclose a method in which a dual-mode device receives information of neighbor base stations and performs handover.

Further, EP Patent No. 1744580 (“Dual-mode mobile terminal and method for handover of packet service call between different communication networks”) discloses a method for providing communication including handover caused by movement of a CDMA/WCDMA dual-mode device.

### DISCLOSURE OF THE INVENTION

### Problems to be Solved by the Invention

The present disclosure is provided to solve the above-described problems, and provides a wireless communication system and method that enables multimedia data to be normally played in a wireless communication device of a user even if there is a delay in handover.

However, problems to be solved by the present disclosure are not limited to the above-described problems. There may be other problems to be solved by the present disclosure.

### Means for Solving the Problems

According to a first aspect of the present disclosure, a wireless communication device may include: a communication module configured to receive multimedia data from a base station of a wireless communication system, and a multimedia module configured to play the received multimedia data. Herein, the communication module receives a backhaul delay time of a handover target base station and performs handover from a current base station to the handover target base station, the multimedia module adjusts a playback time of the multimedia data on the basis of the backhaul delay time when the communication module performs handover, and the backhaul delay time is precalculated by the wireless communication system.

Further, according to a second aspect of the present disclosure, a wireless communication system that provides a wireless communication service to a wireless communication device, may include: a base station configured to transmit multimedia data and its own backhaul delay time to the wireless communication device, and a core network configured to calculate the backhaul delay time of the base station. Herein, the backhaul delay time is used to adjust a playback time of multimedia data when the wireless communication device performs handover from a current base station to a handover target the base station.

Furthermore, according to a third aspect of the present disclosure, a handover method of a wireless communication device, may include: receiving multimedia data from a current base station and playing the multimedia data; receiving a backhaul delay time of a handover target base station; performing handover from the current base station to the handover target base station; and adjusting a playback time of the multimedia data on the basis of the received backhaul delay time at the same time as the performing of handover. Herein, the backhaul delay time is precalculated by a wireless communication system that provides a wireless communication service to a wireless communication device.

Moreover, according to a fourth aspect of the present disclosure, a handover method of a wireless communication system, may include: calculating a backhaul delay time of a base station by the wireless communication system, transmitting the backhaul delay time to a wireless communication device by the base station; and making a determination on which base station handover is to be performed to on the basis of the backhaul delay time.

Further, according to a fifth aspect of the present disclosure, a repacketization module which is located on a path for transmitting multimedia data to a wireless communication device in a wireless communication system, may include: a packet input unit configured to receive a packet to be transmitted to a wireless communication device, separate a packet header from the packet and unpack multimedia packet data; a decoder configured to decode the unpacked multimedia packet data and generate a multimedia signal; a playback time regulator configured to adjust a playback time of the multimedia signal; an encoder configured to encode the multimedia signal of which the playback time is adjusted to configure multimedia packet data of which a playback time is adjusted; and a packet output unit configured to perform repacketization by adding a packet header to the multimedia packet data of which the playback time is adjusted. Herein, the repacketization module may perform repacketization by adjusting a playback time of the multimedia data on the basis of a backhaul delay time of a handover target base station while the wireless communication device performs handover to the handover target base station, the backhaul delay time is calculated by the wireless communication system.

Furthermore, according to a sixth aspect of the present disclosure, a wireless communication system that provides a wireless communication service to a wireless communication device, may include a transmitter configured to transmit multimedia data to the wireless communication device, and a repacketization module which is located on a path for transmitting the multimedia data and performs repacketization by adjusting a playback time of the multimedia data on the basis of a backhaul delay time of a handover target base station while the wireless communication device performs handover to the handover target base station. Herein the backhaul delay time is precalculated by the wireless communication system.

Moreover, according to a seventh aspect of the present disclosure, a handover method of a wireless communication system including a repacketization module located on a path for transmitting multimedia data to a wireless communication device, may include: calculating a backhaul delay time of a base station by the wireless communication system; transmitting the backhaul delay time to a wireless communication device by the base station; determining a handover target base station on the basis of the backhaul delay time; receiving a handover starting time and the backhaul delay time by the repacketization module; and adjusting a playback time of the multimedia data by the repacketization module on the basis of the backhaul delay time while the handover is performed, and outputting a multimedia packet of which a playback time is adjusted.

### Effects of the Invention

According to any one of the above-described aspects of the present disclosure, in a wireless communication system and method, multimedia data can be normally played in a wireless communication device of a user even if there is a delay in handover.

Particularly, when handover is performed to a small cell in a dual-mode wireless communication system, seamless handover can be performed, and, thus, a user may not experience inconvenience caused by a delay.

Multimedia stream accounts for a large portion of the traffic of a wireless communication system, and is a delay-sensitive application as compared with other data. Thus, it is more affected by off-loading to a small cell without inconvenience caused by a delay.

Further, it can be implemented only with the help of software in a device without any change in hardware of a conventional communication system.

### BRIEF DESCRIPTION OF THE DRAWINGS

FIG. 1 illustrates a wireless communication system in accordance with an exemplary embodiment;

FIG. 2 illustrates a configuration of a wireless communication device in accordance with an exemplary embodiment;

FIG. 3 illustrates a configuration of a wireless communication system in accordance with another exemplary embodiment;

FIG. 4 illustrates a configuration of a repacketization module in accordance with another exemplary embodiment;

FIG. 5 illustrates a macro cell and a small cell in accordance with an exemplary embodiment;

FIG. 6 illustrates an exemplary embodiment where handover is performed while a multimedia packet is transferred in a wireless communication system in accordance with an exemplary embodiment;

FIG. 7 illustrates packet retransmission and disappearance caused by a delay of a multimedia packet during handover in a wireless communication system;

FIG. 8 illustrates a time warp caused by a delay of a multimedia packet during handover in a wireless communication system;

FIG. 9 illustrates an example of solving a time warp caused by a delay of a multimedia packet during handover in a wireless communication system in accordance with an exemplary embodiment;

FIG. 10 illustrates another example of solving a time warp caused by a delay of a multimedia packet during handover in a wireless communication system in accordance with an exemplary embodiment;

FIG. 11 illustrates an example where a base station provides information about itself;

FIG. 12 illustrates an example where a current base station provides information about a target base station;

FIG. 13 and FIG. 14 show a flow of a method of receiving information about a target base station from a current base station by a wireless communication device;

FIG. 15 illustrates a flow of a method of playing multimedia data during handover in a wireless communication system in accordance with an exemplary embodiment; and

FIG. 16 illustrates a flow of steps to figure out an expected delay time during handover in a wireless communication system in accordance with an exemplary embodiment.

### MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Hereinafter, a wireless network system supporting a method for searching a wireless LAN by a mobile device to which an exemplary embodiment of the present disclosure is applied will be described in detail with reference to the accompanying drawings.

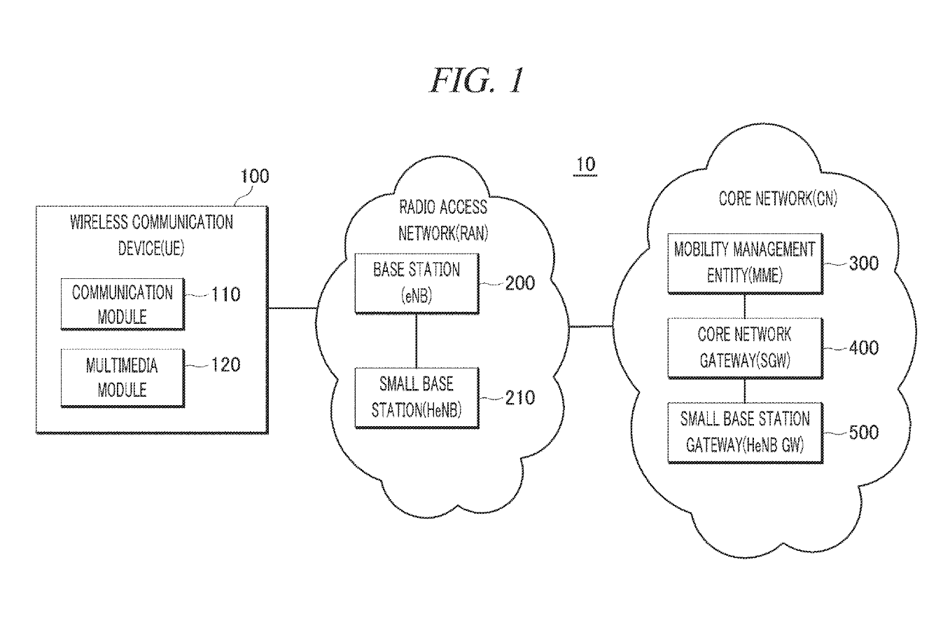

FIG. 1 illustrates a wireless communication system in accordance with an exemplary embodiment.

A wireless communication system 10 in accordance with an exemplary embodiment includes a core network CN as the center of a communication network and a radio access network RAN as an access network configured to connect the core network CN and a wireless communication device (user equipment (UE)) 100 through a RF signal in order to provide a wireless communication function to the UE 100.

The wireless communication system 10 in accordance with an exemplary embodiment may be configured to comply with various wireless communication standards. By way of example, the wireless network system 10 may comply with the LTE-A (Long Term Evolution-Advanced) standards, but may not be limited thereto.

The core network CN may include a mobile management entity (MME) 300 and a serving gateway (SGW) 400. The MME 300 is a critical component of the core network CN in charge of various control functions to provide a wireless communication function to the UE 100. The SGW 400 functions as a router that forwards a user data packet.

In the following, the MME 300 will be referred to as “MME” or “mobile management entity”, and the SGW 400 will be referred to as “SGW” or “core network gateway”.

Moreover, the core network CN may be connected to an external network or the Internet through a PGW (Packet Data Network Gateway (PDN Gateway): not illustrated) or the like. Accordingly, the UE 100 can be provided with various Internet services through cellular communication provided by the wireless communication system 10.

The UE 100 is called various names such as a mobile device, a portable device, a user device, and a user equipment (UE), and refers to a device capable of using a wireless communication function provided by the wireless communication system 10.

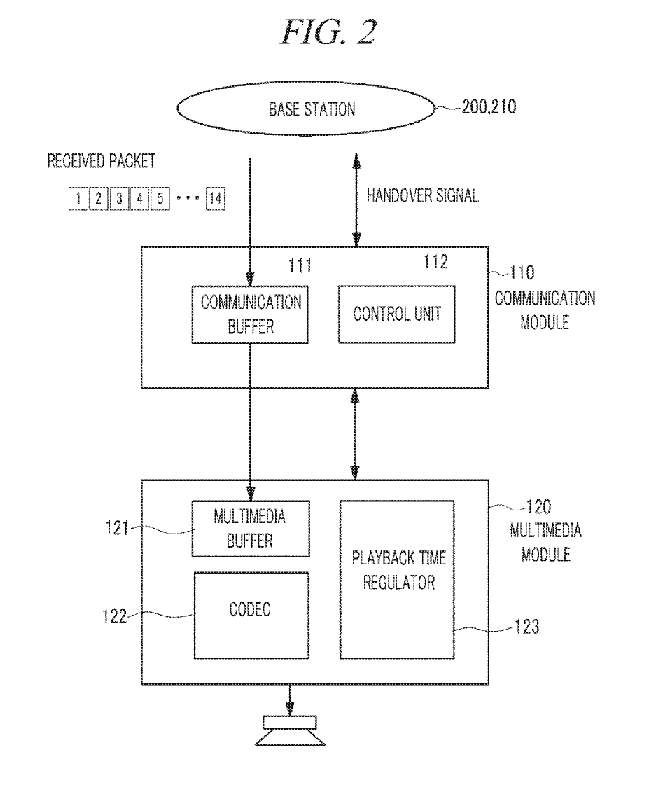

The UE 100 in accordance with an exemplary embodiment of the present disclosure includes a communication module 110 and a multimedia module 120. The communication module 110 is in charge of functions relevant to communication, such as transmitting/receiving data or performing handover, to use a wireless communication service provided by the wireless communication system 10. The multimedia module 120 plays multimedia data and displays them to a user. FIG. 2 illustrates the configuration of the UE 100 in accordance with an exemplary embodiment of the present disclosure in more detail.

The radio access network RAN may include one or more base stations (eNB) 200 and may further include a small base station (HeNB) 210.

Further, the core network CN may further include a HeNB gateway (HeNB GW) 500 to serve the HeNB 210.

The base station 200 may be a transceiver system including all of base stations (BS), relay stations, and the like, and may be called various names such as a cellular network base station and a wireless base station. In the present specification, the base station 200 may be referred to as “eNB (Evolved Node B (eNodeB))”, but may not be limited to the scope of the term. The base station 200 may serve or cover a macro cell (MC). Therefore, in the present specification, the base station 200 may also be referred to as “macro base station 200”.

The small base station 210 is a small-sized base station that has lower power and a smaller coverage (service area) than the macro base station. In the present specification, the small base station 210 may be referred to as “HeNB (Home Evolved Node B (eNodeB))”, but may not be limited to the scope of the term. The small base station 210 may serve or cover a small cell (SC), and the small cell may be, for example, a femtocell. Therefore, in the present specification, the small base station 210 may also be referred to as a small cell base station 210. However, in the present specification, when referred to as “base station 200” without being specified as the small base station 210, the base station may imply the base stations 200 and 210 including the small base station 210.

Recently, small cells have been employed more and more due to their advantages of being able to extend a coverage of a wireless cellular network at low cost and reduce a traffic load of the wireless cellular network. However, in order to do so, the interference problem or the handover delay problem needs to be solved.

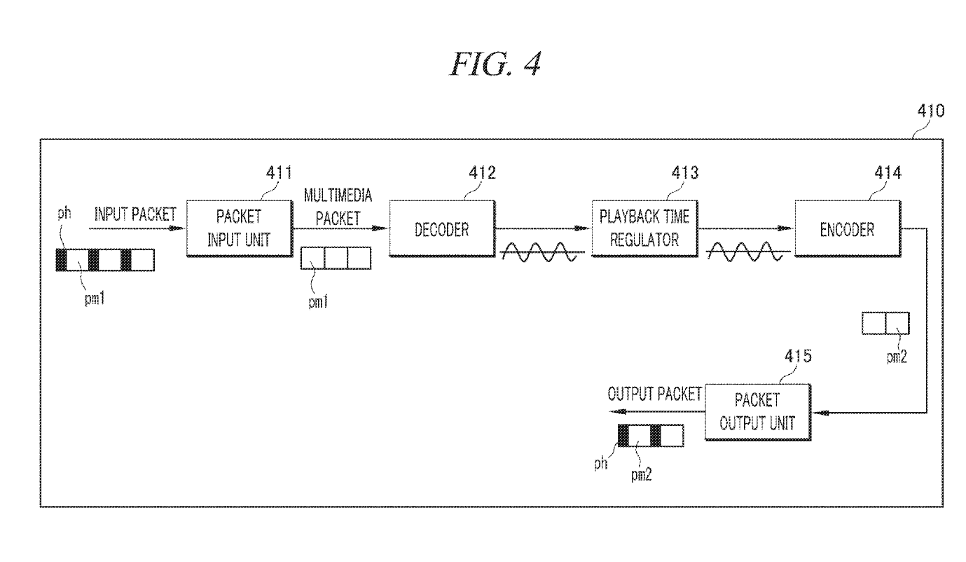

The UE 100 on the move resets a connection to other base stations 200 and 210 having stronger signals in order to keep the connection to the radio access network RAN, which is called “handover”. Meanwhile, a service interruption may be caused by a handover delay to be described with reference to FIG. 4. However, since a delay occurring at the time of handover with respect to a small cell is longer than a delay occurring at the time of handover between macro cells, a service interruption is more likely to occur.

FIG. 2 illustrates a configuration of a wireless communication device in accordance with an exemplary embodiment.

The UE 100 in accordance with an exemplary embodiment of the present disclosure includes the communication module 110 in charge of communication and the multimedia module 120 in charge of presentation of multimedia data. The communication module 110 may include a communication buffer 111 and a control unit 112. Further, the multimedia module 120 may include a multimedia buffer 121, a codec 122, and a playback time regulator 123.

In the UE 100 in accordance with an exemplary embodiment of the present disclosure, during handover, the communication module 110 figures out delay information of the target base stations 200 and 210 to which the handover is performed and transfers the delay information to the multimedia module 120 as an application layer, so that the multimedia module 120 can adjust a playback time.

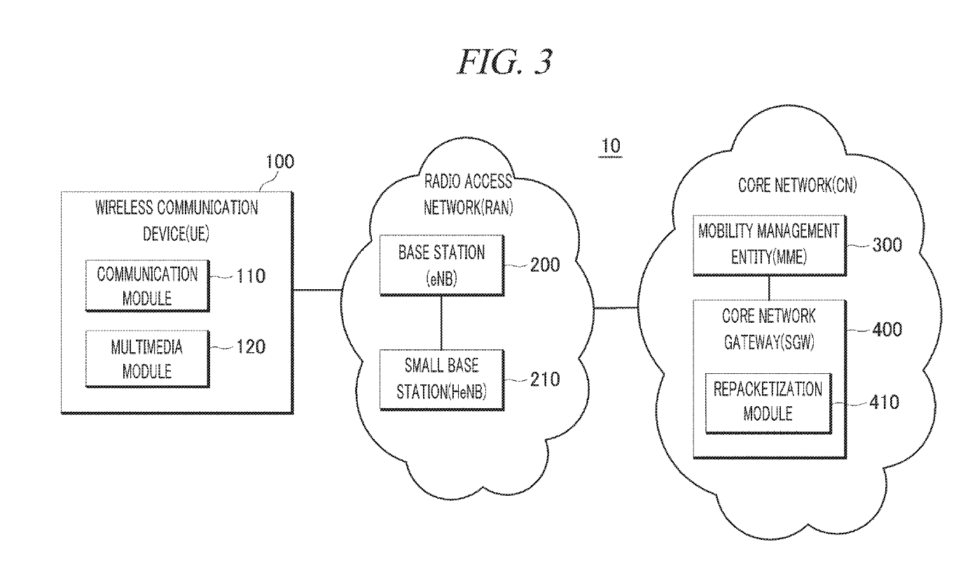

FIG. 3 illustrates a configuration of a wireless communication system in accordance with another exemplary embodiment.

As illustrated in FIG. 3, in the wireless communication system 10 in accordance with another exemplary embodiment, the core network CN includes the mobile management entity (MME) 300 and the serving gateway (SGW) 400. Herein, the SGW 400 may include a repacketization module 410 or may be connected to the repacketization module 410 to transmit and receive data to and from each other. The repacketization module 410 will be described in more detail with reference to FIG. 4.

FIG. 4 illustrates a configuration of a repacketization module in accordance with another exemplary embodiment.

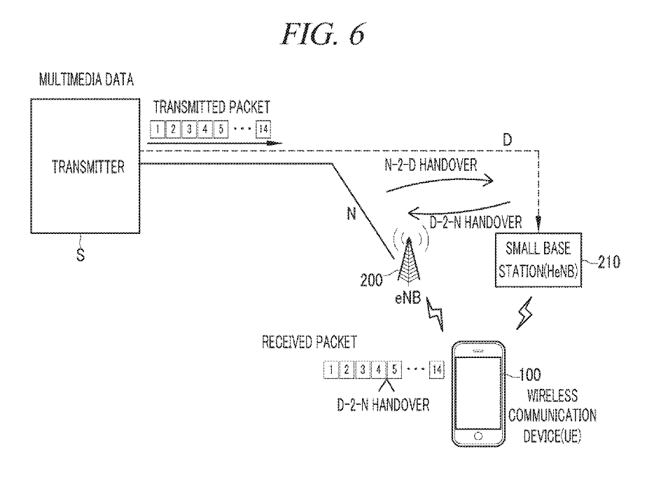

The repacketization module 410 in accordance with another exemplary embodiment may be included in a transmitter S configured to transmit multimedia data of the UE 100 or may operate as being connected to the transmitter S. The transmitter S will be described with reference to FIG. 6. By way of example, the repacketization module 410 may be included in the SGW 400 or may transmit or receive data to and from the SGW 400 as described above. Otherwise, the repacketization module 410 may be located in an entity that controls handover and data transmission in the wireless communication system 10.

The repacketization module 410 receives delay information of the target base stations 200 and 210 to which the UE 100 performs handover and handover time information, adjusts a playback time of multimedia data, and then repacketizes and outputs the multimedia data.

To this end, the repacketization module 410 may include a packet input unit 411, a decoder 412, a playback time regulator 413, an encoder 414, and a packet output unit 415.

The packet input unit 411 receives a packet to be transmitted to the UE 100 and separates a packet header ph from the transmitted packet and then unpacks multimedia packet data pm1.

The decoder 412 decodes the separated multimedia packet data pm1 to configure a multimedia signal.

The playback time regulator 413 adjusts a playback time of the decoded multimedia signal on the basis of a backhaul delay time of the target base stations 200 and 210. By way of example, a signal with a length of 100 msec is adjusted to a signal with a length of 80 msec in the illustrated example.

The encoder 414 encodes the multimedia signal of which a playback time is adjusted to configure multimedia packet data pm2.

The packet output unit 415 repacketizes the multimedia packet data pmt of which a playback time is adjusted by adding a packet header ph thereto.

Meanwhile, a configuration of the repacketization module 410 is not limited to the exemplary embodiment illustrated in FIG. 4. By way of example, a repacketization module in accordance with yet another exemplary embodiment of the present disclosure may output a packet of which a playback time is adjusted by using a transcoding method. The transcoding method refers to a method of converting and encoding an original format into a target format. This method is well known to those skilled in the art, and, thus, a detailed description thereof will be omitted.

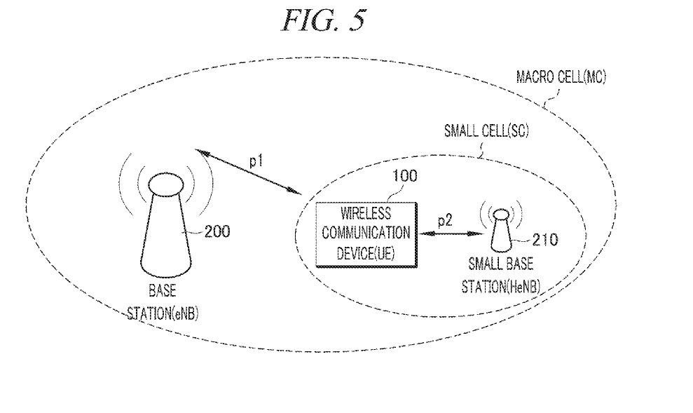

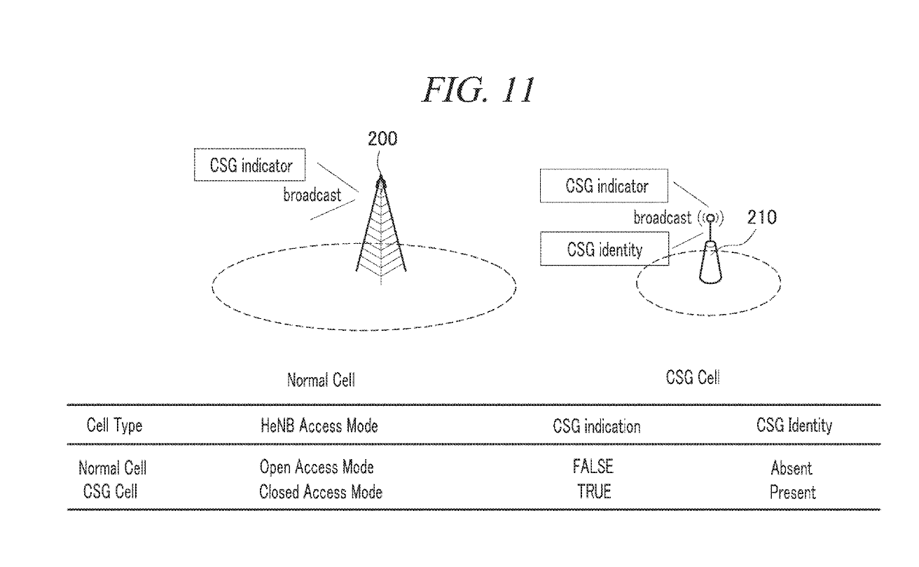

Details about adjusting a playback time will be described later with reference to FIG. 6 to FIG. 10. Details about figuring out delay information will be described with reference to FIG. 11 to FIG. 14. A macro cell and a small cell will be described first with reference to FIG. 5.

FIG. 5 illustrates a macro cell and a small cell in accordance with an exemplary embodiment.

As illustrated in FIG. 5, the UE 100 may transmit and receive radio signals to and from the base station 200 and the small base station 210. The small cell SC has a smaller coverage than the macro cell MC. As illustrated in in FIG. 5, if the small cell SC is present within the macro cell MC (overlay), the wireless communication system 10 may allow the small cell SC, instead of the macro cell MC, to provide a wireless communication service to the UE 100 (off-load) and thus may reduce a traffic load of the macro cell MC.

As illustrated in FIG. 5, if the macro cell MC and the small cell SC are configured to be overlaid with each other, the UE 100 may receive data from the both sides at the same time or may selectively receive data from any one side.

The macro cell MC and the small cell SC may be configured to use different carrier frequencies or may be configured to use the same carrier frequency. Each of the two configurations has advantages and disadvantages.

By way of example, if the macro cell MC uses one frequency and the small cell SC uses the other frequency, the interference problem caused by an influence between the two carrier frequencies may be less serious. However, in order to detect the small cell SC using the other frequency, a service interruption may occur in the macro cell MC. Further, a service interruption may occur during handover and the spectral efficiency may be decreased.

Otherwise, if the macro cell MC and the small cell SC share two frequencies according to the carrier aggregation (CA) technology, it is complicated to perform an operation. However, it is easy to detect the cell and it is possible to efficiently use resources.

FIG. 6 illustrates an exemplary embodiment where handover is performed while a multimedia packet is transferred in a wireless communication system in accordance with an exemplary embodiment.

A process in which a packet transmitted by the transmitter S is transferred to the UE 100 through a network is illustrated. The transmitter S may include various entities present on a transmission path. By way of example, the transmitter S may be a UE 100 of another user. Otherwise, the transmitter S may be a gateway such as the SGW 400 or the HeNB GW 500 of the wireless communication system 10. Alternatively, as illustrated in FIG. 4, the transmitter S may include the repacketization module 410 or may transmit and receive data to and from the repacketization module 410.

In the present specification, a path along which the UE 100 receives multimedia streaming data (e.g., voice data) transmitted by the transmitter S through a current base station (e.g., macro base station 200) is defined as p1 or a normal path N.

Further, a path along which the UE 100 receives data, which has been handed over to another base station (e.g., small base station 210), through the base station is defined as p2 or a delayed path D.

Furthermore, a time required for a multimedia packet transmitted by the transmitter S to arrive at the UE 100 along the normal path N is defined as a normal time TN and a time required for the multimedia packet to arrive along the delayed path D is defined as a delayed time TD.

Further, in the present specification, handover from the macro base station 200 to the small base station 210 is defined as N-2-D handover (Normal-to-Delayed handover) and handover from the small base station 210 to the macro base station 200 is defined as D-2-N handover (Delayed-to-Normal handover).

Generally, a time for data to be transferred through the macro base station 200 is shorter than a time for the data to be transferred through the small base station 210. By way of example, the path to the small base station 210 may further include the HeNB GW 500 which is a gate for the small base station 210 as illustrated in FIG. 1. By way of example, the macro base stations 200 are connected by an X2 interface, but the small base station 210 is not supported by the X2 interface. Thus, the path to the small base station 210 may include the SGW 400 and the HeNB GW 500 of the core network CN through an S1 interface.

Accordingly, the small base station 210 has a longer backhaul delay time than the macro base station 200. Herein, the term “backhaul” refers to an intermediate link between core network CN and a network (e.g., radio access network RAN) at the end of the entire hierarchical network. This term is well known to those skilled in the art, and, thus, a detailed description thereof will be omitted.

If handover from the macro base station 200 to the small base station 210 is not performed, i.e., in case of the normal path N, packets 1, 2 . . . , 14 of multimedia streams transmitted by the transmitter S are received by the UE 100 after a delay of D0. If handover is performed, i.e., in case of the delayed path D, there is an additional delay of D1, and, thus, the packets are received by the UE 100 after a delay of D0+D1.

By way of example, D0 may be 40 msec and D1 may be 50 msec. In this case, since D0+D1 is shorter than 100 msec, call quality requirements are satisfied. For reference, in case of voice communication, it is required to maintain a delay of less than 100 msec for call quality, and in case of game applications, it is required to maintain a delay of less than 50 msec. Therefore, if D1 is increased, the requirements regarding a service delay cannot be satisfied. Thus, the user of the UE 100 may experience inconvenience such as call disconnection or pause of playback of multimedia data.

That is, a shorter delay means a better service quality. Thus, it is very desirable to have a delay as short as possible in terms of QoS/QoE. Particularly, loss of multimedia packets during handover considerably deteriorates a multimedia service quality.

By way of example, if a target network (e.g., small cell served by the small base station 210) has a longer packet delay than a current network (e.g., macro cell served by the base station 200) during handover, a packet may be repeatedly received.

As illustrated in the drawings, off-loading to a heterogeneous network (e.g., Wi-Fi network) is preferred due to overload to a cellular network. Therefore, introduction of the small cell SC has attracted a lot of attention as an alternative capable of overcoming the limitations of a conventional cellular network based on the macro base station 200. However, a Wi-Fi or a backhaul network for the small cell SC uses the existing Ethernet infrastructure. Thus, it is impossible to expect a delay in a communication path as compared with a backhaul network for the macro cell MC. Further, the delay in the communication path is increased.

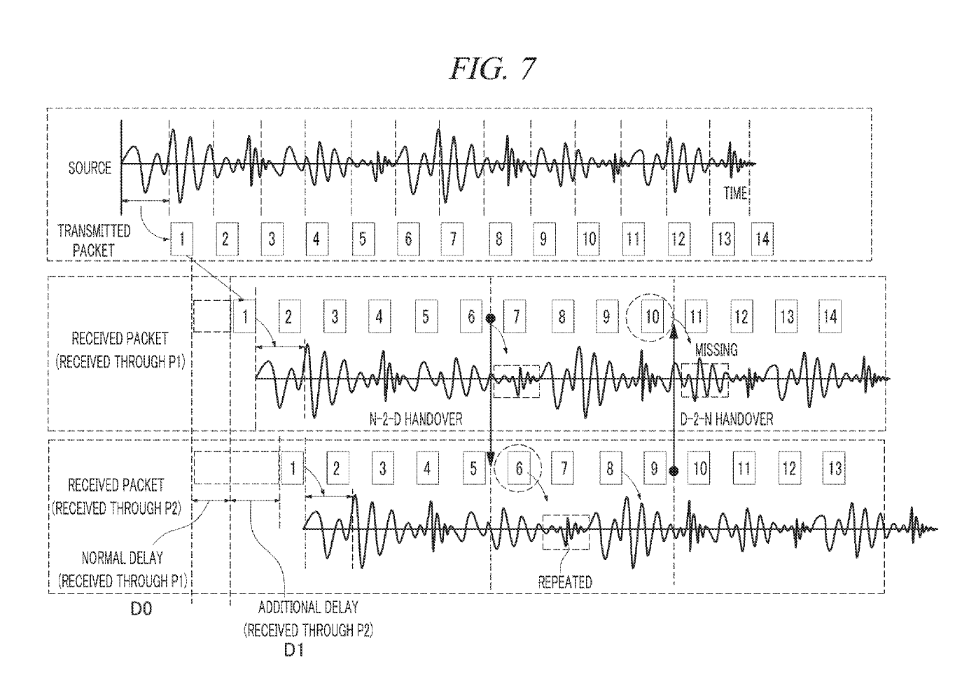

Meanwhile, in case of a delay-sensitive multimedia traffic such as VoIP or real-time broadcast, a delay in a communication path during handover is not consistent with a delay in a conventional path including the macro cell MC. Details thereof will be described with reference to FIG. 7 to FIG. 10.

FIG. 7 illustrates packet retransmission and disappearance caused by a delay of a multimedia packet during handover in a wireless communication system.

As illustrated in FIG. 7, if N-2-D handover, i.e., handover from the normal path N to the delayed path D, is performed, a packet 6 of packets of the UE 100 may be repeatedly transmitted. In view of real-time data in a decoding application thereof, it can be said that repetition of a multimedia signal corresponding to the packet 6 occurs.

If the base stations 200 and 210 are smart, they can suppress repetition of the packet 6. However, in this case, a time for a packet 7 to arrive at the UE cannot be reduced. That is, a delay of D1 cannot be solved and thus may be treated as a kind of a standby mode with inoffensive noise or silence. However, such a treatment causes a significant warp.

Further, if D-2-N handover, i.e., handover from the delayed path D to the normal path N, is performed, a packet may be missed. That is, if handover is performed after a packet 9 is received, a packet 10 is already in the past on the normal path N and it is time to receive a packet 11. Thus, a multimedia signal corresponding to the packet 10 is missing.

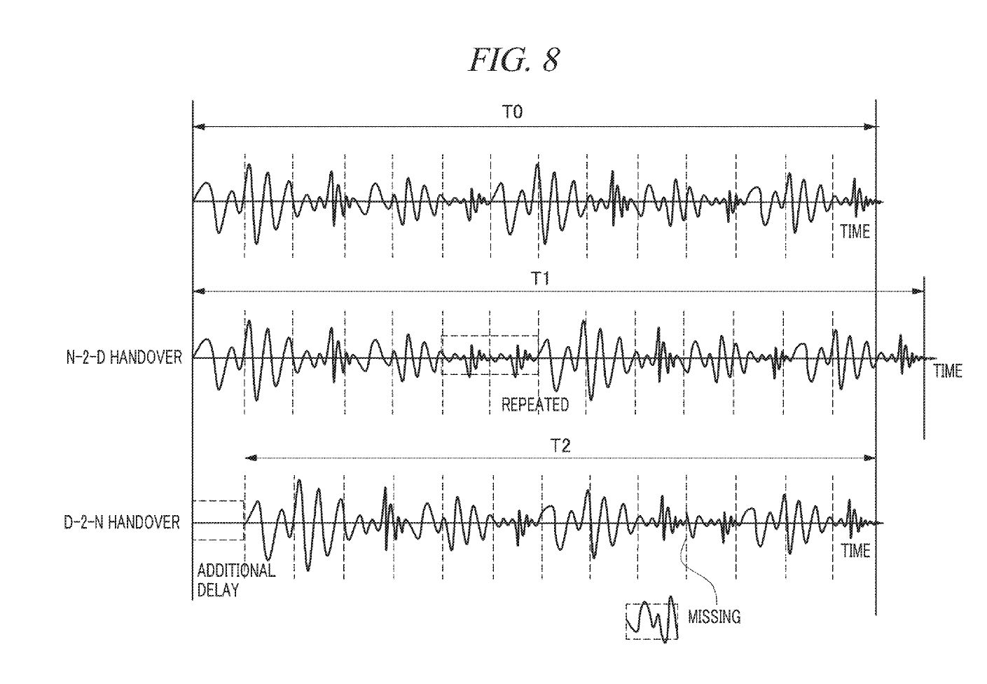

FIG. 8 illustrates a time warp caused by a delay of a multimedia packet during handover in a wireless communication system.

Referring to FIG. 8, if N-2-D handover is performed to a voice input corresponding to T0 8, the problem illustrated in FIG. 7 causes an increase of a playback time to T1 including a repetition section. Further, in case of D-2-N handover, a playback time is decreased to T2 due to a packet missing section. However, in both cases, there may be a significant quality deterioration such as content discontinuity.

Such discontinuity may affect the quality of multimedia contents such as videos, sounds (voices, audio), and games. Particularly, discontinuity in sound contents may generate an unpleasant click noise and thus may cause a significant deterioration of QoS/QoE.

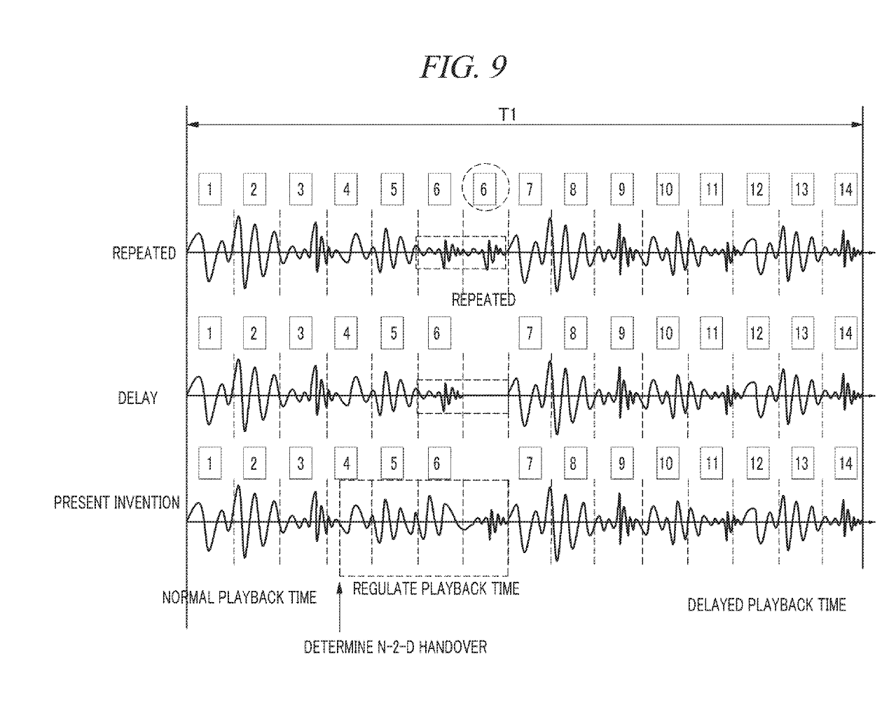

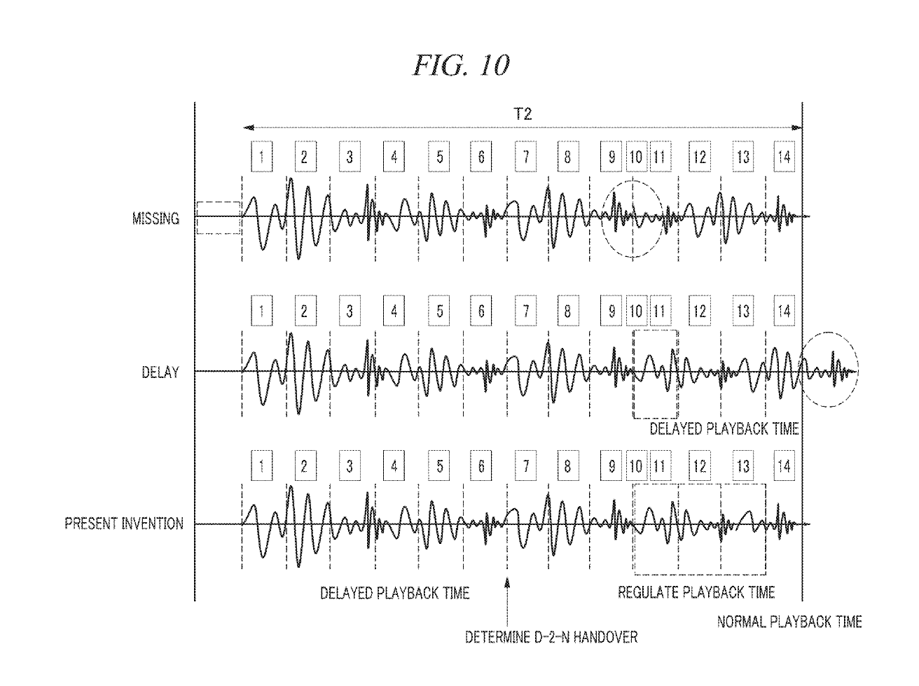

A method for solving this problem by the wireless communication system in accordance with an exemplary embodiment of the present disclosure will be described with reference to FIG. 9 and FIG. 10.

FIG. 9 illustrates an example of solving a time warp caused by a delay of a multimedia packet during handover in a wireless communication system in accordance with an exemplary embodiment.

The situation to be solved in FIG. 9 is an increase of a playback time of contents to be played in the UE in case of N-2-D handover. That is, as illustrated in FIG. 6, the contents having a playback time length of T0 includes a repetition section, and, thus, the playback time length is increased to T1.

To solve this problem, as illustrated in FIG. 7, a time warp is mitigated using presentation time shift (PTS), and, thus, the quality of contents to be played can be improved in accordance with an exemplary embodiment of the present disclosure.

If data to be transmitted are multimedia contents, such as audio and video, tending to be transmitted in real time, the PTS generally refers to the technology of varying a presentation time of the multimedia contents without changing emotional quality of the multimedia contents. Herein, the term “emotional quality” may include tone, pitch, and the like in case of audio or may include uniformity in frame interval in case of video. That is, in case of an audio signal, the PTS may use time scale modification (TSM) technology of varying a presentation time while maintaining frequency characteristics (tone, pitch, etc.) of the input audio signal as much as possible. Herein, the TSM may include time scale compression (TSC) for reducing a presentation time or time scale expansion (TSE) for increasing a presentation time. Further, the TSM may use an algorithm such as PSOLA (Pitch Synchronous Overlap and Add), but may not be limited thereto. PTS, TSM, and PSOLA are prior arts, and, thus, detailed descriptions thereof will be omitted.

More specifically, as illustrated in the third drawing, in the present disclosure, time scale expansion starts from a time when handover is determined and then transition is performed until a time (a time when the packet 7 arrives and is played in the illustrated example) corresponding to a playback time of the delayed path D. In this case, a starting point of a section for performing PTS is the time when handover is determined.

Further, in accordance with an exemplary embodiment of the present disclosure, the current base station 200 may transmit a delay value, i.e., D1, of the handover target base station 210, as additional information. The UE may regulate TSM factors with reference to D1.

FIG. 10 illustrates another example of solving a time warp caused by a delay of a multimedia packet during handover in a wireless communication system in accordance with an exemplary embodiment.

FIG. 10 illustrates an example of seamless handover according to a method suggested in the present disclosure in case of D-2-N handover.

In case of a conventional technology in which a multimedia stream is played upon receipt by a device, a jump is allowed while the packet 10 is left missing as illustrated in the first drawing. In this case, a warp caused by discontinuity occurs.

In an example illustrated in the second drawing, during handover, the packet 10 is transferred to the UE without a jump and the UE plays the packet 10 according to a delayed playback time. In this case, discontinuity does not occur during handover. However, even after return to a normal time (TN) domain, the packet 10 is played according to a delayed time TD. Such a delay significantly affects QoS/QoE of real-time contents and thus is not desirable. For example, if 1 hour is used in a normal section after a 10-second stay on the delayed path D, it means that most of a playback section is used as being delayed although a normal delay is possible.

The third drawing shows a method suggested in the present disclosure, and this method includes a process of performing PTS to adjust a playback time to a normal playback time. In the same manner as illustrated in FIG. 7, at PTS is performed a time when the occurrence of D-2-N handover is recognized and then transition is performed in order for a playback time to be in a normal playback time.

Herein, in accordance with another exemplary embodiment of the present disclosure, the transmitter S may include the repacketization module 410 or may transmit and receive data to and from the repacketization module 410. The repacketization module 410 may perform repacketization as described with reference to FIG. 4 during transition.

Therefore, the examples illustrated in FIG. 9 and FIG. 10 will be explained again as follows.

FIG. 9 illustrates an example where the repacketization module 410 performs time scale expansion. In an exemplary embodiment of the present disclosure, in case of handover from the normal path N to the delayed path D (N-2-D handover), n number of packets are expanded to m number of packets (n<m) while the handover is performed (i.e., during a transition section) in order to follow a playback time of the delayed path D. The UE 100 decodes and plays the received m number of packets in sequence. At a time when the handover is completed (i.e., normal section), the UE 100 receives and decodes packets transmitted thereafter through the handover path. Therefore, the UE 100 enables seamless playback of multimedia data.

FIG. 10 illustrates an example where the repacketization module 410 performs time scale compression, which can be applied to a case of handover from the delayed path D to the normal path N (D-2-N handover). In an exemplary embodiment of the present disclosure, n number of packets are compressed to m number of packets and then transmitted (n>m). The UE 100 receives packets through the delayed path D until a transition section starts, and then the handover is performed. Then, the UE 100 receives and plays the m number of packets during the transition section. Likewise, at a time when the handover is completed (i.e., normal section), the UE 100 receives and plays packets transmitted thereafter through the handover path. Therefore, the UE 100 enables seamless playback of multimedia data without any action.

There has been explained a method of solving repetition and missing of a multimedia packet caused by a delay during handover by adjusting a playback time in a wireless communication system in accordance with an exemplary embodiment of the present disclosure with reference to FIG. 9 and FIG. 10.

In accordance with an exemplary embodiment of the present disclosure, the communication module 110 of the UE 100 and the multimedia module 200 in charge of a multimedia service interwork with each other. Therefore, by transferring delay information parameters (e.g., D1) of the handover target network 210 to the multimedia module 200 during handover, the multimedia module 200 can adjust a playback time (PTS). Thus, the quality of a multimedia service of the wireless communication system 10 can be improved.

Further, the wireless communication system 10 in accordance with another exemplary embodiment of the present disclosure may include the repacketization module 410 and transfer the delay information parameters (e.g., D1) of the target network 210 to which handover is to be performed by the UE 100 to the repacketization module 410. Therefore, the repacketization module 410 outputs the packets of which a playback time is adjusted. That is, a multimedia packet of which a playback time is adjusted can be transferred to the UE 100, and, thus, the quality of a multimedia service to be provided to the UE 100 can be improved.

It is desirable to start PTS from or after a time when handover is determined, and it is desirable to set up a PTS section considering a difference in backhaul delay between the transmitter S and the target base station 210 or a backhaul difference of the target base station 210.

That is, the wireless communication system 10 in accordance with an exemplary embodiment of the present disclosure solves repetition and missing of a multimedia packet caused by a delay during handover by mitigating the delay through PTS using TSM. In accordance with an exemplary embodiment of the present disclosure, the UE 100 or the repacketization module 410 of the UE starts adjusting a playback time from a time when handover is determined and performs transition until the playback time is consistent with a playback time of delayed path D. That is, a PTS section starts from a time when handover is determined.

In this case, the current base station 200 may transmit a delay value, i.e., D1, of the handover target base station 210 as additional information. The UE may regulate TSM factors with reference to D1.

It can be implemented only with software interworking between the communication module 110 and the multimedia module 120 in the UE 100 without any change in hardware of a conventional communication system. Considering a high data ratio of delay-sensitive live contents, it is expected to become a very important solution to realize an offloading scenario to the small cell SC.

Further, the repacketization module 410 in accordance with another exemplary embodiment of the present disclosure receive multimedia data together with handover time information and expected delay information of the UE 100. The repacketization module 410 is located on a path along which multimedia data are transmitted to the UE 100, and, thus, the repacketization module 410 can receive the above-described information from various entities on the path.

Hereinafter, an example where the UE 100 is provided with delay information of the handover target base station 210 from the current base station 200 will be described with reference to FIG. 11 to FIG. 14. For convenience in explanation, the small base station 210 will be described as the target base station.

FIG. 11 illustrates an example where a base station provides information about itself.

Each of the macro base station 200 on the left of the drawing and the small base station 210 on the right broadcasts information about itself. In the example illustrated in the drawing, the macro base station 200 is a normal cell operating in an open access mode, and the small base station 210 is a closed subscriber group (CSG) cell configured to provide a service only to a registered UE 100. However, if the small base station 210 allows an open access, the small base station 210 also functions as a normal cell.

Cell information broadcasted by the base stations 200 and 210 themselves include a CSG indicator and a CSG identity (CSG ID) as illustrated in the drawing. In case of the normal cell 200, a CSG indicator is set as FALSE and a CGS ID is absent (i.e., not broadcasted). In case of the CSG cell 210, a CSG indicator is set as TRUE and a CSG ID includes effective data.

The UE 100 which approaches each of the base stations 200 and 210 and receives a broadcast signal can identify whether a base station approached by the UE 100 is the normal cell 200 or the CSG cell 210 from the CSG indicator. At the same time, the UE 100 can identify whether the base station is the CSG cell 210 at which the UE 100 is registered or the normal cell 200 from the CSG ID.

Further, the core network CN of the wireless communication system 10 can detect a backbone handover delay on the basis of a CSG indicator and a CSG ID broadcasted by each cell. For example, the wireless communication system 10 may precalculate a backbone handover delay by checking a network status (e.g., ping).

Therefore, when broadcasting information about themselves, the base stations 200 and 210 can also transmit backhaul delay time information. The UE 100 can select a handover target base station 210 from among various candidate base stations with reference to the received delay information.

In this case, the UE 100 can cache information about the corresponding CSG cell. Then, when the UE 100 approaches the cell next time, the UE 100 can automatically perform handover to the CSG cell without receiving backhaul delay time information or selecting a target cell on the basis of the delay information.

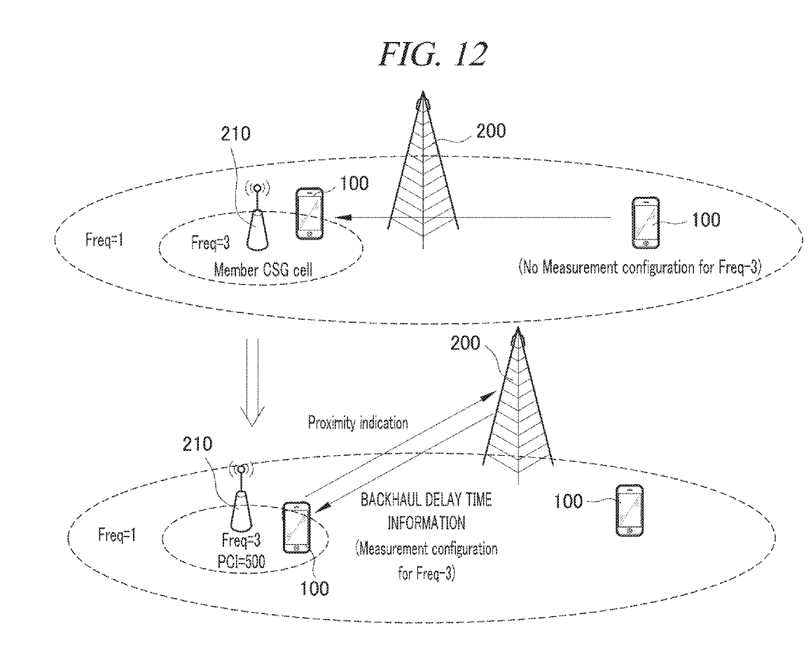

FIG. 12 illustrates an example where a current base station provides information about a target base station.

A measurement process in which the UE 100 receives information about the handover target base station 210 is performed under the control of the current base station 200. If it is reported to the current base station 200 that the UE 100 approaches the CSG cell 210, the current base station 200 may transmit backhaul delay time information of the base station 210 to the UE 100.

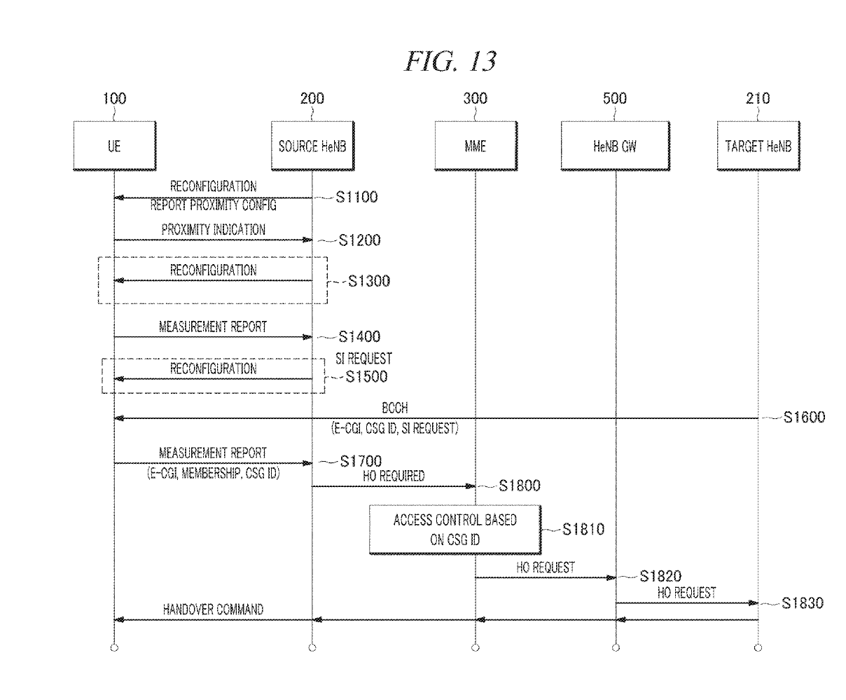

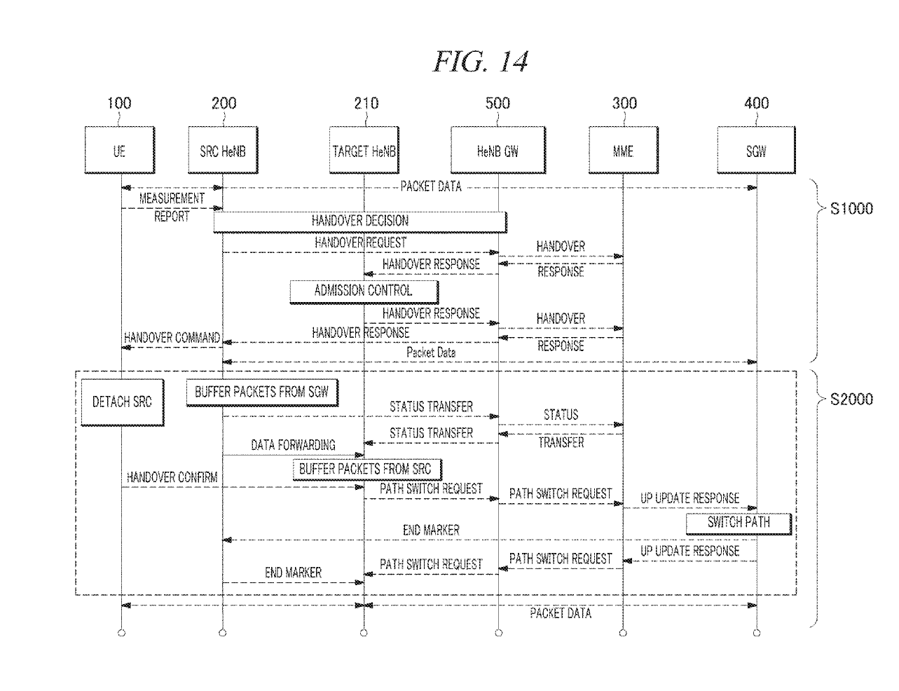

FIG. 13 and FIG. 14 show a flow of a method of receiving information about a target base station from a current base station by a wireless communication device.

FIG. 13 illustrates a process in which when the UE 100 approaches a candidate target base station 210, the UE 100 receives backhaul delay time information from the current base station 200 as explained in FIG. 12 and makes a determination on which target base station 210 handover is to be performed to.

In S1100 to S1500, if the UE 100 moves to approach the candidate target base station 210, this approach is reported to the current base station 200 together with information such as signal quality.

Then, the UE 100 receives information, such as CGS ID and backhaul delay time information, as described in FIG. 11 from the candidate target base station 210 (S1600) and reports the received information to the current base station (S1700).

During the above-described process, the UE 100 and the current base station 200 have mutual communication and make a determination on which one of the candidate target base stations 210 handover is to be performed to. For example, the UE 100 may make a determination on which target base station handover is to be performed to considering backhaul delay time information or the like and then report the determination to the current base station 200. Otherwise, if the UE 100 reports information about all the candidate target base stations 210, the current base station 200 may select a target base station 210.

Then, the current base station 200 transmits a handover request message to the target base station 210. In this case, the target base station 210 is a small base station 210, and, thus, the handover request message is transferred through the components of the core network CN as illustrated in FIG. 6.

Then, the target base station 210 transmits a handover command to the UE 100.

FIG. 14 illustrates the same case as illustrated in FIG. 13 except that the current base station 200 is also a small base station 210.

In S1000, backhaul delay time information is provided to determine handover as explained in FIG. 13, and in S2000, handover is performed. As illustrated in FIG. 14, the processes are basically the same as those illustrated in FIG. 13, and, thus, an explanation thereof will be omitted.

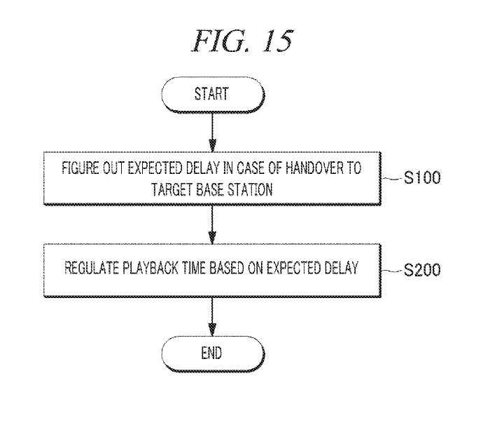

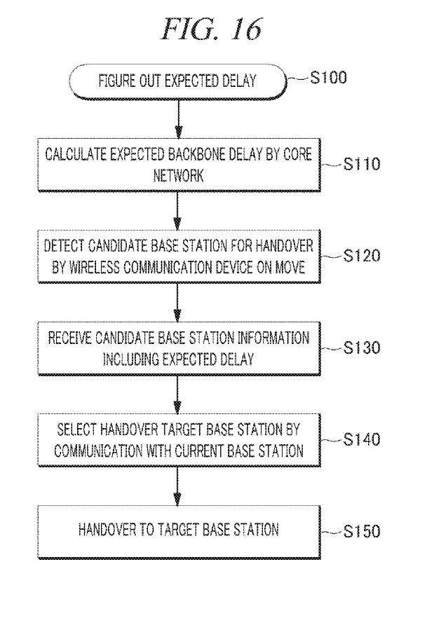

Adjusting of a playback time for seamless handover during transmission and playback of a multimedia packet has been explained with reference to FIG. 6 to FIG. 10, and figuring out delay information required to this end has been explained with reference to FIG. 11 to FIG. 14. A method of playing multimedia data during handover by using them will be explained with reference to FIG. 15 and FIG. 16.

FIG. 15 illustrates a flow of a method of playing multimedia data during handover in a wireless communication system in accordance with an exemplary embodiment.

An expected delay (backbone handover delay) which may occur during handover to the target base station 210 is figured out (S100). Details thereof have been described with reference to FIG. 11 to FIG. 14.

A playback time is adjusted on the basis of the expected delay during handover (S200). Details thereof have been described with reference to FIG. 6 to FIG. 10.

FIG. 16 illustrates a flow of steps to figure out an expected delay time during handover in a wireless communication system in accordance with an exemplary embodiment.

Firstly, the core network CN calculates an expected backbone delay (S110). It can be figured out using a ping signal or the like as described above. Therefore, each of the base stations 200 and 210 may have its own expected backbone delay information.

The UE 100 on the move detects a candidate base station 210 for handover (S120).

The UE 100 receives candidate base station information including an expected delay (S130). The candidate base station 210 broadcasts its own expected backbone delay information together with its own cell ID, CSG indicator, etc. as described above.

The UE 100 selects a handover target base station by communication with the current base station (S140). In this case, as described above, the UE 100 may refer to delay information of the candidate base station 210.

The UE 100 performs handover to the target base station (S150). At the same time, S200 is also performed. That is, the multimedia module 120 of the UE 100 regulates TSM factors with reference to the delay information and adjusts a playback time from a time when handover is determined and then performs transition until a time corresponding to a playback time of the delayed path D.

Hereinafter, a flow of repacketization (S200) of the wireless communication system during handover in accordance with another exemplary embodiment of the present disclosure will be described.

A packet to be transmitted to the UE 100 is input (S210).

Multimedia data are unpacked from the packet (S220) and then decoded (S230).

A playback time of the multimedia data is adjusted on the basis of the expected delay during handover as figured out in S100 (S240). The above-described method such as TSM or the like may be used.

After encoding (S250), a multimedia packet of which a playback time is adjusted is output (S260).

The multimedia packet is transmitted to the UE 100 (S270).

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A wireless communication device comprising:
a communication module configured to receive multimedia data from a base station of a wireless communication system; and
a multimedia module configured to play the received multimedia data,
wherein the communication module receives a backhaul delay time of a handover target base station and performs handover from a current base station to the handover target base station,
the multimedia module adjusts a playback time of the multimedia data on the basis of the backhaul delay time when the communication module performs handover, and
the backhaul delay time is precalculated by the wireless communication system.

2. The wireless communication device of claim 1,
wherein if the current base station is a macro base station, the handover target base station is a small cell base station, and if the current base station is a small cell base station, the handover target base station is a macro base station.

3. The wireless communication device of claim 1,
wherein the communication module makes a determination on which base station handover is to be performed to on the basis of the backhaul delay time.

4. The wireless communication device of claim 1,
wherein the communication module receives, from the current base station, information about the handover target base station determined on the basis of the backhaul delay time.

5. A wireless communication system that provides a wireless communication service to a wireless communication device, comprising:
a base station configured to transmit multimedia data and its own backhaul delay time to the wireless communication device; and
a core network configured to calculate the backhaul delay time of the base station,
wherein the backhaul delay time is used to adjust a playback time of multimedia data when the wireless communication device performs handover from a current base station to a handover target base station.

6. The wireless communication system of claim 5,
wherein if the current base station is a macro base station, the handover target base station is a small cell base station, and if the current base station is a small cell base station, the handover target base station is a macro base station.

7. The wireless communication system of claim 5,
wherein the wireless communication system receives, from the wireless communication device, information about which base station handover is to be performed to on the basis of the backhaul delay time.

8. The wireless communication system of claim 5,
wherein the base station makes a determination on which base station the wireless communication device is handed over to on the basis of the backhaul delay time.

9. A handover method of a wireless communication device, comprising:
receiving multimedia data from a current base station and playing the multimedia data;
receiving a backhaul delay time of a handover target base station;
performing handover from the current base station to the handover target base station; and
adjusting a playback time of the multimedia data on the basis of the received backhaul delay time at the same time as the performing of handover,
wherein the backhaul delay time is precalculated by a wireless communication system that provides a wireless communication service to a wireless communication device.

10. The handover method of claim 9, further comprising:
making a determination on which base station handover is to be performed to on the basis of the backhaul delay time.

11. A handover method of a wireless communication system, comprising:
calculating a backhaul delay time of a base station by the wireless communication system;
transmitting the backhaul delay time to a wireless communication device by the base station; and
making a determination on which base station handover is to be performed to on the basis of the backhaul delay time.

12. The handover method of claim 11,
wherein the backhaul delay time is used to adjust a playback time of multimedia data when the wireless communication device performs handover to the base station.

13. A repacketization module which is located on a path for transmitting multimedia data to a wireless communication device in a wireless communication system and performs repacketization by adjusting a playback time of the multimedia data on the basis of a backhaul delay time of a handover target base station while the wireless communication device performs handover to the handover target base station,
wherein the backhaul delay time is calculated by the wireless communication system.

14. The repacketization module of claim 13, comprising:
a packet input unit configured to receive a packet to be transmitted to a wireless communication device, separate a packet header from the packet and unpack multimedia packet data;
a decoder configured to decode the unpacked multimedia packet data and generate a multimedia signal;
a playback time regulator configured to adjust a playback time of the multimedia signal;
an encoder configured to encode the multimedia signal of which the playback time is adjusted to configure multimedia packet data of which a playback time is adjusted; and
a packet output unit configured to perform repacketization by adding a packet header to the multimedia packet data of which the playback time is adjusted.

15. The repacketization module of claim 13,
wherein the repacketization module repacketizes the multimedia data by transcoding.

16. The repacketization module of claim 13,
wherein the repacketization module receives the backhaul delay time and information about a starting time of the handover.

17. The repacketization module of claim 13,
wherein the repacketization module receives the backhaul delay time calculated by the wireless communication system using a ping signal.

18. A wireless communication system that provides a wireless communication service to a wireless communication device, comprising,
a transmitter configured to transmit multimedia data to the wireless communication device; and
a repacketization module which is located on a path for transmitting the multimedia data and performs repacketization by adjusting a playback time of the multimedia data on the basis of a backhaul delay time of a handover target base station while the wireless communication device performs handover to the handover target base station,
wherein the backhaul delay time is precalculated by the wireless communication system.

19. The wireless communication system of claim 18,
wherein the repacketization module is included in or connected to the transmitter and exchanges data with the transmitter.

20. The wireless communication system of claim 18,
wherein the repacketization module receives the backhaul delay time and information about a starting time of the handover.

21. The wireless communication system of claim 18,
wherein the repacketization module includes:
a packet input unit configured to receive a packet to be transmitted to a wireless communication device, separate a packet header from the packet and unpack multimedia packet data;
a decoder configured to decode the unpacked multimedia packet data and generate a multimedia signal;
a playback time regulator configured to adjust a playback time of the decoded multimedia signal;
an encoder configured to encode the multimedia signal of which the playback time is adjusted to generate multimedia packet data of which a playback time is adjusted; and
a packet output unit configured to perform repacketization by adding a packet header to the multimedia packet data of which the playback time is adjusted.

22. The wireless communication system of claim 18,
wherein the wireless communication system calculates the backhaul delay time using a ping signal.

23. A handover method of a wireless communication system including a repacketization module located on a path for transmitting multimedia data to a wireless communication device, comprising:
calculating a backhaul delay time of a base station by the wireless communication system;
transmitting the backhaul delay time to a wireless communication device by the base station;
determining a handover target base station on the basis of the backhaul delay time;
receiving a handover starting time and the backhaul delay time by the repacketization module; and
adjusting a playback time of the multimedia data by the repacketization module on the basis of the backhaul delay time while the handover is performed, and outputting a multimedia packet of which a playback time is adjusted.

24. The handover method of claim 23,
wherein the backhaul delay time is calculated by the wireless communication system using a ping signal.
